(19) United States
(12) Patent Application Publication
(10) Pub. No.: US 2022/0055909 A1
(43) Pub. Date: Feb. 24, 2022

(54) METHOD FOR SYNTHESIZING ZEOLITIC SOLIDS CONTAINING MESOPORES AND CONTROLLED-SIZE PARTICLES

(71) Applicants: Petróleo Brasileiro S.A. - Petrobrás, Rio de Janeiro (BR); FUNDAÇÃO UNIVERSIDADE FEDERAL DE SÃO CARLOS - UFSCAR, São Carlos (BR)

(72) Inventors: Darley Carrijo De Melo, Rio de Janeiro (BR); Wilson Mantovani Grava, Rio de Janeiro (BR); Dilson Cardoso, São Carlos (BR); Jailson De Arruda Araújo, São Carlos (BR)

(73) Assignees: Petróleo Brasileiro S.A. - Petrobrás, Rio de Janeiro (BR); FUNDAÇÃO UNIVERSIDADE FEDERAL DE SÃO CARLOS - UFSCAR, São Carlos (BR)

(21) Appl. No.: 17/395,788

(22) Filed: Aug. 6, 2021

(30) Foreign Application Priority Data
Aug. 19, 2020 (BR) 10 2020 016940 8

(51) Int. Cl. C01B 39/48; B01J 20/18

(52) U.S. Cl. CPC C01B 39/48; B01J 20/183; B01J 2220/4812; C01P 2006/16; B01J 2220/4806; C01P 2004/64

(57) ABSTRACT

The present invention relates to a method of synthesis of zeolitic LTA adsorbents containing intercrystalline mesoporosity and controlled particle size, which can, for example, be used in natural gas dehydration processes, seeking to comply not only with the specifications on moisture content in the natural gas, but also improving the efficiency of the gas drying process in regard to the adsorption kinetics, not compromising the adsorption capacity, water selectivity, and the regeneration cycles of the adsorbent. Another possible application of these compounds is as the support for catalysts for oil refining processes. The method of obtaining the zeolitic adsorbent solids, the purpose of this invention, consists of including an aging step of the reaction mixture in conjunction with the addition of N,N-dimethyl-N-[3-(trimethoxysilane)propyl]octadecyl ammonium chloride (TPOAC) to the reaction mixture.

### FIELD OF THE INVENTION

This invention relates to the development of zeolitic adsorbents containing intercrystalline mesoporosity, which, for example, may be used in natural gas dehydration processes, with the objectives of complying with established specifications for the moisture content in natural gas in the oil industry, and improving the efficiency of the gas dehydration process, without compromising adsorption capacity, water selectivity, and the regeneration cycles of the adsorbent used.

Another possible application of this zeolitic molecular sieve is to serve as support for catalysts for oil refining processes.

Zeolitic adsorbents, which are the purpose of this invention, were obtained through a novel method in relation to those existing in the state of the art, which consists of inserting an aging step of the reaction mixture into the synthesis process, which provides the zeolitic material obtained with improved textural property, specifically an adaption to the particle size. The addition of a surfactant to the reaction mixture is responsible for providing the material with mesoporosity. Therefore, the resulting molecular sieve has a zeolite structure; that is, it is a crystalline microporous material comprised mainly of aluminum and silicon, with two additional characteristics: it presents mesoporosity and controlled particle size (in the nanometer range), which results in greater efficiency in the process of adsorbing water from the gas stream, leading to the use of smaller beds, which require less space and energy in the production units.

### DESCRIPTION OF THE STATE OF THE ART

The characteristic composition of the natural gas produced by oil wells requires prior dehydration of the gas stream. This step is necessary because the presence of water in the vapor phase in the gas can cause blockage of the gas pipelines, due to the accumulation of methane hydrates, as well as corrosion. Particularly in the pre-salt reservoirs, the moisture content in the gas must be below 1 ppm.

The solutions for the natural gas dehydration process traditionally use triethylene glycol, TEG, which is technology based on liquid-gas absorption, and currently commercial zeolitic molecular sieves. The first technology does not adequately meet the specifications of maximum moisture content required in the treated gas stream. The use of zeolitic molecular sieves complies with the moisture-related specifications, but presents an elevated cost due to the size of the adsorption columns and to low performance in regard to the adsorption kinetics.

More specifically, for dehydration of natural gas to 40 ppm, then to the limit required for the gas produced on the platforms in the Campos Basin (approximately 2 lb H₂O/MMscf of gas), the process normally used is based on absorption columns, using (triethylene glycol) TEG as the hygroscopic liquid. However, after the discovery of the pre-salt block, this method was found to have some limitations, the main one being the water content obtained in the processed gas, which was well above 1 ppm. This rigorous specification was established in order to prevent the formation of hydrates, or even to avoid corrosion processes in reinjection lines in the reservoir (for secondary oil recovery methods), or in gas export lines, subsequently subjected to low temperatures and extremely high pressures in pre-salt areas.

Several works show the application of molecular sieves, especially the zeolites, as high-potential adsorbents in the drying of natural gas, as can be seen in Fendler, J. H. “Nanoparticles and nanostructured films: preparation, characterization and applications,” Wiley-VCH, Weinheim, 1998 and Giannetto, G. “Zeólitas—Caracteristicas, propiedades y aplicaciones industriales” [Zeolites—Characteristics, properties and industrial applications], EdIT-Editorial Innovación Tecnológica, 1990.

The fact that the physical adsorption process is completely reversible is an additional advantage in the use of zeolites. The structure of a zeolite during the adsorption process remains intact, and regeneration is possible through the processes of desorption of the adsorbate, thus preventing decomposition of the adsorbent, as occurs with other drying agents.

More recently there has been a search for zeolitic materials with improved textural properties, in order to handle problems related mainly to diffusional limitations, as described in Wang, Y; Ren, F.; Pan, D.; Ma, J. “A Hierarchically Micro-Meso-Macroporous Zeolite CaA for Methanol Conversion to Dimethyl Ether,” Crystals, v.6, pp.155, Nov. 2016, Serrano, D. P., Escolac, J. M.; Pizarroab, P. “Synthesis strategies in the search for hierarchical zeolites,” Chem. Soc. Rev. v.42, pp.4004-4035, 2013, and Wei, Y.; Parmentier, T. E.; De Jong, K. P., “Tailoring and visualizing the pore architecture of hierarchical zeolites,” Chem. Soc. Rev., v.44, pp. 7234-7261, October 2015.

Thus obtaining adsorbents whose structure presents both microporosity, an intrinsic property of zeolites, as well as meso or macroporosity, has been studied. To that end, there are two approaches that are based on the constructive (bottom-up) method, or the destructive (top-down) method.

In the first approach (bottom-up), the material is formed from two of its precursor reagents, such as silica and alumina, and for example, growth-inhibiting agents are added, usually surfactants such as N,N-dimethyl-N-[3-trimethoxysilane)propyl]octadecyl ammonium chloride (TPOAC). The second approach (top-down) starts from a previously formed material, with which only post-synthesis treatments are done, usually using acids and bases. The cited methods are found in Wang, Z.; Cho, Li; Cho, H. J.; Kung, S. C.; Snyder, M. A.; Fan, W. “Direct, single-step synthesis of hierarchical zeolites without secondary templating,” J. Mater. Chem. A, v.3, pp. 1298-1305, 2015 and Mitchell, S.; Pinar, A. B.; Kenvin, J.; Crivelli, P.; Karger, J.; Pérez-Ramirez, J. “Structural analysis of hierarchically organized zeolites,” Nature Communications, v.6, pp. 8633, Octpber 2015.

The zeolitic materials derived from both methods are frequently called zeolites with a hierarchical pore system, or simply zeolites containing mesopores, as disclosed in Valtchev, V.; Mintova, S. “Hierarchical zeolites,”MRS Bulletin, v.41, pp. 689-693, September 2016, and G.-Martinez, J.; Li, K., Davis, M. E. “Mesoporous Zeolites: Preparation, Characterization and Applications,” John Wiley & Sons, May 2015.

Different from the commercial adsorbents formed by this type of zeolite, and that present particles that are micrometric in size, the nanometric zeolites exhibit shorter channels and a larger external surface area, resulting in a shorter diffusion path, thus favoring the adsorption kinetics, as mentioned in Hu, Y. et al., “Microwave-assisted hydrothermal synthesis of nanozeolites with controllable size,”Microporous andMesoporous Materials, v.119, pp. 306-314, March 2009, Camblor, M. A. et al., “Progress in Zeolite and Microporous Materials,” Stud Surf. Sci. Catal. v.105, 1997, and Mintova, S.; Gilson, J. P.; Valtchev, V. “Advances in nanosized zeolites,” Nanoscale, v.15, pp. 6693-6703, August 2013.

The document BAZAN, R. E., et al.; “Adsorçäo de gases puros e suas misturas presentes no gas natural por zeólita tipo LTA,” [Adsorption of pure gases and their mixtures present in natural gas due to the LTA zeolite], X Encontro Brasileiro sobre Adsorçäo [X Brazilian Summit on Adsorption], eba10, 2014, shows that the natural gas extracted from the pre-salt reserves presents significant quantities of impurities and water, which, if not removed or reduced, may cause serious problems, such as pipe obstruction due to the formation of hydrates. The work also reports that drying using molecular sieves is one of the most promising means, using zeolites with nanometric-sized particles, which exhibit shorter intracrystal channels and larger external surface area than that of traditional zeolites, which results in shorter length of the diffusion path and also favors exposure of a larger number of active sites to perform the role of catalyst or adsorbent.

This invention is an evolution of the article by BAZAN, R. E., et al.; “Adsorçäo de gases puros e suas misturas presentes no gas natural por zeólita tipo LTA” [Adsorption of pure gases and their mixtures present in natural gas due to the LTA zeolite] X Encontro Brasileiro sobre Adsorçäo [X Brazilian Summit on Adsorption], eba10, 2014. However, in the mentioned work the principal objective in the zeolite characteristic was the size of the particles, while this invention, in addition to including the aging step of the reaction mixture in determining the size of the particles, also considers the presence of mesoporosity to be important, to decrease the resistance of the adsorption process and to improve the efficiency of the adsorbent. To do this, the reaction mixture was aged by adding a surfactant agent responsible for conferring mesoporosity on the zeolite, particularly the TPOAC.

The document KHAN, G. M. A., et al.; “Linde Type-A zeolite synthesis and effect of crystallization on its surface acidity,” Indian Journal of Chemical Technology, vol. 17, pp. 303-308, 2010, discusses the synthesis of zeolite A (LTA), from sodium aluminate and sodium metasilicate, through a hydrothermal process. More specifically, it reveals a process of LTA zeolite synthesis in which the source of silica, in particular the sodium metasilicate and the sodium aluminate, are dissolved separately in a solution of sodium hydroxide, mixed until homogenized, with the formation of a viscous gel, placed in Teflon® cups, left to rest for one hour, and taken to a crystallization step. The resulting solid is subsequently cooled, washed and dried.

Note that in document KHAN, G. M. A., et al.; “Linde Type-A zeolite synthesis and effect of crystallization on its surface acidity,” Indian Journal of Chemical Technology, vol. 17, pp. 303-308, 2010, there is no mention of whether there was temperature control, and furthermore, what that temperature would be. As seen in this invention, one hour of crystallization is not sufficient to form the structure of the zeolite. That is, the process described in the document does not have the step of aging the reaction mixture, because it is not able to form a crystalline structure before the crystallization process.

The document by CHO, K., et al.; “Generation of Mesoporosity in LTA zeolites by Organosilane Surfactant for Rapid Molecular Transport in Catalytic Application,” Chemistry of Materials, 2009 presents the control of the mesoporosity of the LTA zeolite by use of organosilane surfactants in the synthesis process. The document also shows that the increased mesopore size is obtained when the quantity of surfactant is increased, given that the surfactant acts as the mesoporosity-creating agent. Zeolites thus obtained show differences in selectivity, catalytic activity, and in the time of their useful life, which results are attributed to rapid transport in the zeolitic micropores and externally via mesopores.

The article by CHO, K., et al.; “Generation of Mesoporosity in LTA zeolites by Organosilane Surfactant for Rapid Molecular Transport in Catalytic Application,” Chemistry of Materials, 2009, reveals how a zeolitic material containing mesoporosity is obtained, but without controlling the size of the particles at the end of the process, because the method used does not contain an aging step prior to the crystallization.

The method of the present invention includes using reagents (source of silica, source of aluminum, solvent) and a surfactant agent to create mesoporosity in zeolites, after submitting the reaction mixture (reagents and surfactant) to two specific steps: aging followed by crystallization. The order of application of these steps cannot be altered to obtain, in the end, a material with the LTA zeolite structure (which depends on the reagents), which has a microporous and crystalline structure, but with two other particularities at the same time; to wit, mesoporosity and controlled particle size (in the nanometer range), resulting in a compound with greater efficiency in the water adsorption process, meaning smaller beds, which require less space and energy in the production units.

Document CN103214003 shows the preparation of a mesoporous zeolitic molecular sieve involving the mixture of sodium silicate, water, and a Y-type zeolite orientation agent for 1 to 4 hours at ambient temperature and the slow addition of N,N-dimethyl-N-[3-(trimethoxysilane)propyl]-octadecyl ammonium chloride (TPOAC) as an agent of mesoporosity. The procedure does not include, however, an aging step, in conformance with the method that is the purpose of this invention.

U.S. Pat. No. 8,273,153 reveals a method for liquefaction of a natural gas containing water and heavy hydrocarbons with more than five carbon atoms, being preceded by the gas dehydration step. The document highlights that the water needs to be removed from the natural gas to prevent the formation of hydrates at low temperatures, which may block the lines and heat exchangers of the liquefaction plant.

Furthermore, U.S. Pat. No. 8,273,153 shows that the natural gas flows through an adsorbent to be dehydrated, and that the materials used as adsorbents to dry natural gas may be selected from among molecular sieves of the family commonly referred to as LTA, which comprise 3A molecular sieves, 4A molecular sieves, and 5A molecular sieves.

U.S. Pat. No. 8,273,153 also describes that mesoporous adsorbents may be used to remove a large quantity of water contained in the gas. The insertion of different charge-compensating cations occurs in a step subsequent to that of zeolite synthesis and may be applied without difficulty to the micro and mesoporous material obtained in this invention. This does not make a difference to the result of the method of this invention, which is obtaining the zeolite A containing mesoporosity, and at the same, controlled particle size (in the nanometer range). It is highlighted that the charge-compensating cations influence the opening of the structure's micropores, depending on the ionic ray of the cation used, and not on the size of its particles.

After it is synthesized, the zeolite obtained using the method that is the purpose of this invention, is a zeolite 4A containing mesopores and with nanometric particles, and in conformance with the insertion of cations in a step subsequent to the ionic exchange, it may become 3A or 5A, which is a third characteristic and whose step is not part of the method of this invention.

U.S. Pat. No. 8,273,153 cites that prior to dehydration the gas may pass through a mesoporous adsorbent, which may be chosen from among activated alumina and silica gel, which are two materials with a composition that is completely different from the composition of the zeolites. The document discusses the use of two adsorbent beds of different materials: one bed of mesoporous adsorbents, probably with the objective of retaining liquids such as water and heavy hydrocarbons, and a bed of zeolite A for the gas dehydration step (removing vapor from the gas), properly stated.

Different than what is described in this patent, the method of the present invention leads to obtaining a single material, which includes, simultaneously, characteristics of mesoporous and microporous materials, as it has a zeolite 4A with nanometric particles and mesoporosity.

No document in the state of the art reveals a synthesis of zeolites containing mesopores and controlled particle size for use in drying natural gas as this invention does.

This invention was developed in order to resolve these issues, and consists of developing an LTA zeolite structure containing mesopores, with the objective of being used in the drying of natural gas. In addition, through the new method presented, the dimensions of the particles can be controlled, and the nanometric scale can be reached by aging the reaction mixture.

This invention seeks to satisfy two characteristics required in the natural gas drying process: reduction of the moisture content, and increase in the speed of water adsorption. More specifically, the zeolitic material resulting from this invention combines two characteristics that are important for the adsorption. The first refers to water selectivity, as it deals with an adsorbent compound already used for this application, and the second is with respect to the quite favorable adsorption kinetics, as intercrystalline mesoporosity was developed both in the particles with micrometric dimensions, as well as in those with nanometric dimensions, allowing access to the micropore more quickly. This was possible due to rigorously following the steps referring to the method developed in this invention.

Different from commercial adsorbents, this invention allows rapid access to the micropores of the zeolitic adsorbent due to its mesoporosity and the shorter channels obtained by the nanometric size of the particles.

The synthesis procedure of this invention is simple: it does not use an organic director for formation of the structure, and the steps are easily to perform. There is also the possibility of adjusting the chemical composition of the reaction mixture in order to make it possible not to use sodium hydroxide and to reduce water content in the synthesis of the adsorbents. This is quite beneficial, as it significantly reduces the alkaline waste from the process.

This invention may have several advantages for the oil and gas industry. Among them is the reduction or total elimination of the amount of commercial adsorbents, the domain of own technology, the possibility of domestic scale-up, and the possibility of extending the method of synthesis to other materials used in the oil and gas industry, such as catalyst supports for oil refining and other demands of the area.

### SUMMARY DESCRIPTION OF THE INVENTION

The present invention relates to a method of synthesis of zeolitic adsorbents containing intercrystalline mesoporosity, which not only comply with the specifications for application in the process of natural gas dehydration; they also improve efficiency of the drying process in regard to the kinetics of water adsorption, not compromising the adsorption capacity, water selectivity, and the regeneration cycles of the adsorbent.

The zeolitic adsorbents obtained in this invention may allow construction of smaller adsorption columns, which is a crucial factor for process optimization and cost reduction, due to use of less space in the industrial plant.

The method developed in this invention for the synthesis of new adsorbent compounds is quite simple; however, the details make it exclusive, principally in regard to the order of the steps to be followed.

### BRIEF DESCRIPTION OF THE DRAWINGS

The present invention will be described in greater detail below, referencing the attached figures, which clearly and unrestrictedly of the inventive scope, provide examples of its realization. The designs show:

FIG. 1 illustrates X-ray diffractograms of the LTA zeolite obtained in this invention without TPOAC, with addition of TPOAC in the reaction mixture and with different aging times;

FIG. 2 illustrates a mass-loss thermogram of the LTA zeolite samples obtained in this invention without the addition of TPOAC and with the addition of the surfactant in the reaction mixture and with different aging times;

FIG. 3 illustrates a thermogram of the result of the loss of mass of the LTA zeolite samples obtained in this invention without the addition of TPOAC and with the addition of the surfactant in the reaction mixture and with different aging times;

FIG. 4 illustrates N₂ physisorption isotherms from the LTA zeolite sample obtained in this invention without the addition of TPOAC and with the addition of the surfactant in the reaction mixture with variation in the aging time;

FIG. 5 shows a micrography obtained using sweep electron microscopy of the LTA zeolite sample obtained in this invention, without the addition of TPOAC, without aging of the reaction mixture, and with a 50KX increase;

FIG. 6 shows a micrography obtained using sweep electron microscopy of the LTA zeolite sample obtained in this invention, without the addition of TPOAC, without aging of the reaction mixture, and with a 100KX increase;

FIG. 7 shows a micrography obtained using sweep electron microscopy of the LTA zeolite sample obtained in this invention, with the addition of TPOAC, without aging of the reaction mixture, and with a 50KX increase;

FIG. 8 shows a micrography obtained using sweep electron microscopy of the LTA zeolite sample obtained in this invention, with the addition of TPOAC, without aging of the reaction mixture, and with a 100KX increase;

FIG. 9 shows a micrography obtained using sweep electron microscopy of the LTA zeolite sample obtained in this invention, with the addition of TPOAC, without aging of the reaction mixture for 48 h, and with a 50KX increase;

FIG. 10 shows a micrography obtained using sweep electron microscopy of the LTA zeolite sample obtained in this invention, with the addition of TPOAC, with aging of the reaction mixture for 48 h, and with a 150KX increase;

FIG. 11 shows a micrography obtained using sweep electron microscopy of the LTA zeolite sample obtained in this invention, with the addition of TPOAC, with aging of the reaction mixture for 96 h, and with a 50KX increase;

FIG. 12 shows a micrography obtained using sweep electron microscopy of the LTA zeolite sample obtained in this invention, with the addition of TPOAC, with aging of the reaction mixture for 96 h, and with a 150KX increase;

### DETAILED DESCRIPTION OF THE INVENTION

The present invention consisted of developing a method of synthesis to obtain zeolitic adsorbents containing mesopores, one of whose objectives is application in the drying of natural gas. With the new method, the dimensions of the particles can be controlled, and the nanometric scale can be reached through the aging of the reaction mixture.

The zeolitic adsorbent obtained in this invention combines two important characteristics for the adsorption processes. The first corresponds to water selectivity, and the second is related to the quite favorable adsorption kinetics, as there is generation of intercrystalline mesoporosity both in the zeolitic particles with micrometric dimensions, as well as in those with nanometric dimensions, allowing more rapid access to the zeolite micropores. This is possible due to rigorously following the steps present in the method of this invention.

The method developed for synthesis of optimized adsorbent materials in the present invention is quite simple; however, the details make it exclusive, mainly in relation to the order of the steps to be followed.

The method of this invention consists of inclusion of an aging step of the reaction mixture in conjunction with the addition of N,N-dimethyl-N-[3-(trimethoxysilane)propyl]octadecyl ammonium chloride (TPOAC) to the reaction mixture.

The synthesis of the adsorbents was based on two methods published previously, as described in Thompson, R. W.; Huber, M. J., “Analysis of the Growth of Molecular Sieve Zeolite NaA in a Batch Precipitation System,” J. Cryst. Gr., v.56, pp. 711-722, 1982; and in Cho, K., Cho, H. S., Menorval, L. C., Ryoo, R., “Generation of Mesoporosity in LTA Zeolites by Organosilane Surfactant for Rapid Molecular Transport in Catalytic Application,” Chem. Mater., v.21, pp. 5664-5673, November 2009.

The procedure consists of the following steps:
Prepare two solutions: SOLUTION A, containing: deionized water, sodium hydroxide, sodium metasilicate, and TPOAC. The mixture should be agitated (100 to 400 rpm) for 15 to 45 minutes, or a sufficient amount of time to dissolve the silica source. It is necessary for the TPOAC surfactant to be added in this step; that is, prior to aging the reaction mixture, as its subsequent addition compromises formation of the mesoporous zeolite.
SOLUTION B, containing: deionized water, sodium hydroxide and sodium aluminate. The mixture should be agitated (100 to 400 rpm) for 15 to 45 minutes, or enough time to dissolve the source of alumina.
Next, solutions A and B are mixed (SOLUTION A under SOLUTION B) and left to agitate mechanically for 30 to 190 minutes (400 to 600 rpm) until total homogenization, which is characterized by a white-colored, more viscous reaction mixture than in the precursor solutions.
The reaction mixture is then divided into smaller portions, placed in Teflon® cups, and left in a thermostatic bath (25 to 35° C.) for the aging step of the reaction mixture, with aging times varying from 0 to 96 hours.
Once the aging time of the reaction mixture has passed, the containers are placed in stainless steel autoclaves for oven thermal treatment, with internal air circulation between 90 and 110° C. for 3 to 5 hours.
Finally, the solid compound obtained is collected, cooled, filtered, washed with deionized water until it has a pH close to 8, and dried in an oven at 80° C.

The type of zeolite obtained from the method developed in the present invention may allow construction of smaller adsorption columns in natural gas dehydration processes, which is a crucial factor for optimizing and reducing costs, as it means taking up less space at an industrial plant.

### EXAMPLES

Various embodiments were realized with the post-synthesis material in powder form, in order to verify the intended structure and the new properties acquired by the adsorbent with the application of the new method. The embodiments and the principal results acquired were:

### a) X-Ray Diffractometry

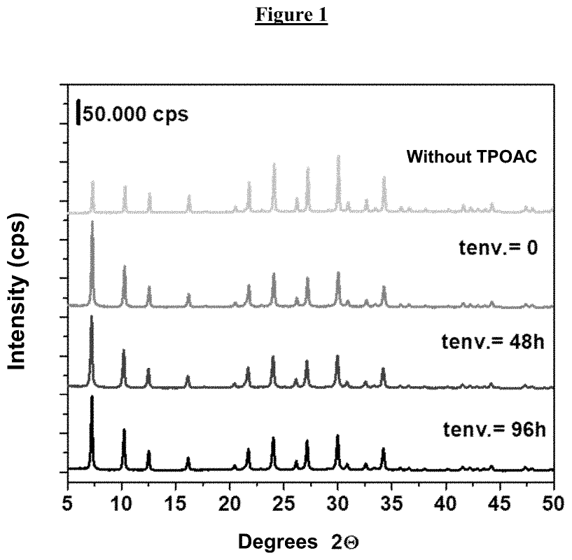

This analysis was done to obtain the diffraction profiles of the samples, and to evaluate the intended structure or crystalline phase. A Miniflex 600 diffractometer from Rigaku was used, and radiation of CuKα (λ=0.1542 nm) with a sweep angle in the region of Bragg 2 θ=5-50°, under the conditions of 40 KV and 15 mA, a nickel filter and goniometer speed of 10° (2 θ)/min. The samples were evaluated in powder form, compacted on a glass slide. The diffractograms are shown in FIG. 1, where the profiles of the LTA zeolites obtained with the addition of TPOAC to the reaction mixture with different aging times can be seen.

Comparing the diffraction profiles obtained with the official collection of diffraction standards available on the site of the International Zeolite Association—IZA, zeolite formation with an LTA structure was found. The presence of the additive (surfactant) did not harm formation of the zeolite 4A.

### b) Thermogravimetric Analysis

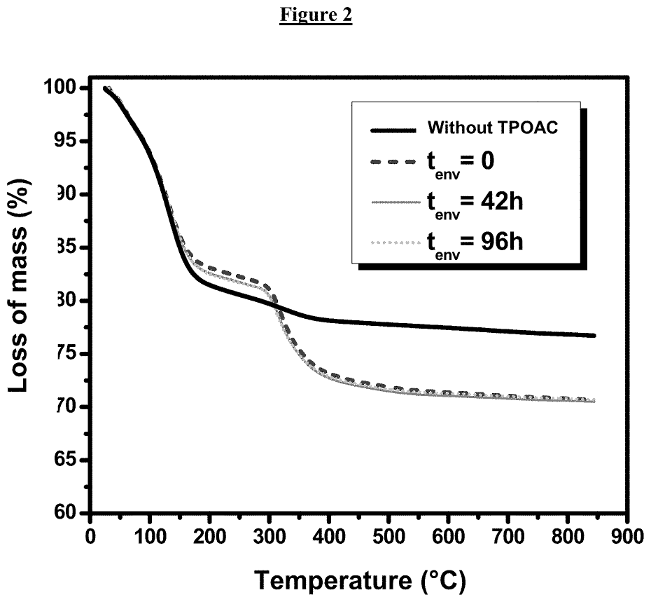

Mass-loss profiles were obtained with the temperature for the samples obtained. Thermograms were generated using a thermobalance (TA Instruments SDQ 600). The samples were subjected to an oxidizing atmosphere (synthetic air), using a heating rate of 10° C.min⁻¹, until reaching a temperature of 850° C., and air discharge of 30 mL.min⁻¹. The thermograms are illustrated in FIG. 2 for LTA zeolites obtained without the addition of TPOAC and with the addition of TPOAC in the reaction mixture with variation in the aging time.

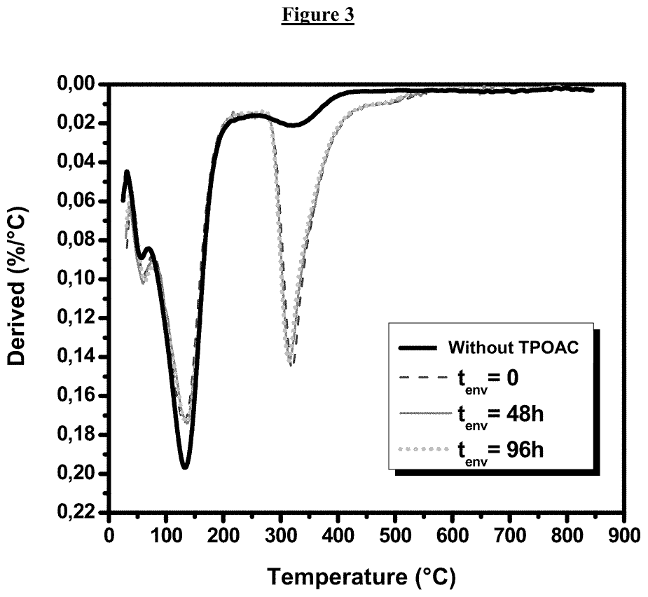

FIG. 3 shows the derivatives of the losses of mass from the synthesized zeolitic adsorbents in the presence of a surfactant, whose reaction mixture was aged for 0 h, 48 h, and 96 h. The curves show two principal regions of mass loss: (I) temperature 30-200° C. and (II) temperature 200-500° C.

These regions for the material without surfactant (x=0.00) basically represent a loss of physisorbed water in the alpha cavity (region I) and loss of water in the sodalite cavity (region II), as described in the works of Tounsia, H., Mseddi, S., Djemel, S. “Preparation and characterization of Na-LTA zeolite from Tunisian sand and aluminum scrap,” Physics Procedia, v.2, pp.1065-1074, 2009 and Demontis, P.; Gulin-Gonzalez, J.; Jobic, H.; Masia, M.; Sale, R.; Suffritti, G. B. “Dynamical Properties of Confined Water Nanoclusters: Simulation Study of Hydrated Zeolite NaA: Structural and Vibrational Properties,” ACS Nano, v. 2, pp. 1603-1614, 2008.

The materials synthesized in the presence of a surfactant presented a profile in which there was an increase of the signal in region II when the surfactant was added, suggesting that it is the area where the TPOAC decomposes.

### c) Physisorption of Nitrogen at 77K

This technique was used to determine the textural properties of the material, such as external area and volume of holes. An ASAP 2020 machine from Micromeritics was used for this. Initially, the samples were placed in a vacuum for one hour at a temperature of 200° C. for removal of the physisorbed water from the surface of the adsorbent. After treatment, volume measurements were taken of N₂ adsorbed for each sample at low pressures, at the boiling point of liquid nitrogen (−196° C.).

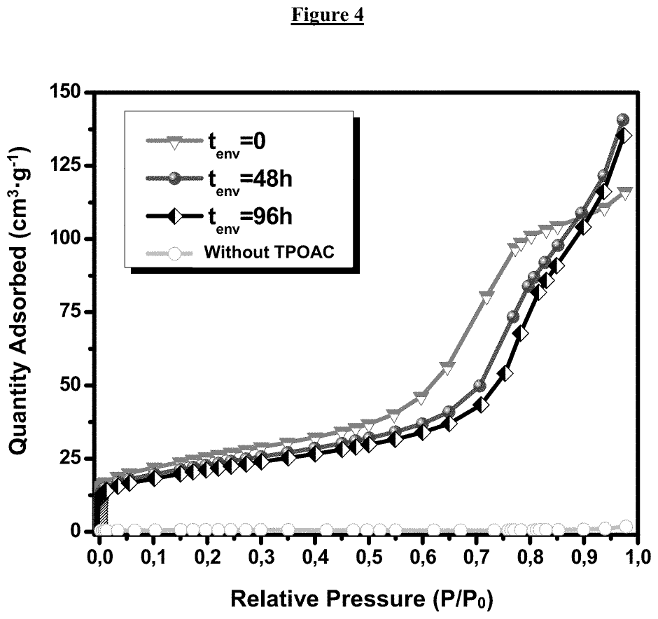

The isotherms are illustrated in FIG. 4, which presents the isotherms from nitrogen physisorption at 77K of the zeolitic adsorbents prepared in the presence of the surfactant, whose reaction mixture was aged for Oh (without aging of the reaction mixture), 48 h, and 96 h. The results showed a significant change in the profile of the isotherm in relation to the synthesized material without surfactant (x=0.00). The adsorbents prepared in the presence of the surfactant presented nitrogen adsorption due to the appearance of intercrystalline mesoporosity.

### d) Electronic Sweep Microscopy

The materials obtained were evaluated in relation to the crystalline habit and to the other characteristics in regard to the format of the particles, using the sweep electron microscopy technique.

The samples were prepared using approximately 50 mg of powder, dispersed in methyl alcohol under ultrasound for 30 minutes. The supernatant was dripped onto an aluminum sample slide until a fine layer was obtained. The images were collected using an FEI sweep microscope, model Magellan 400L.

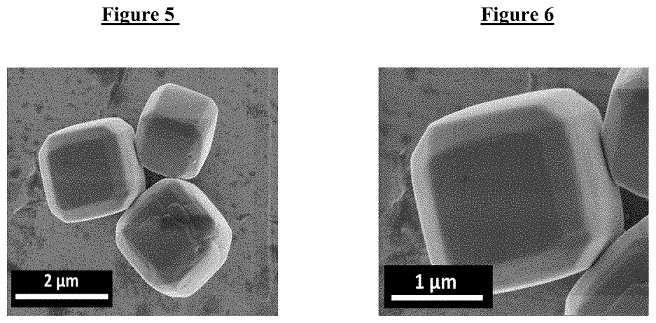

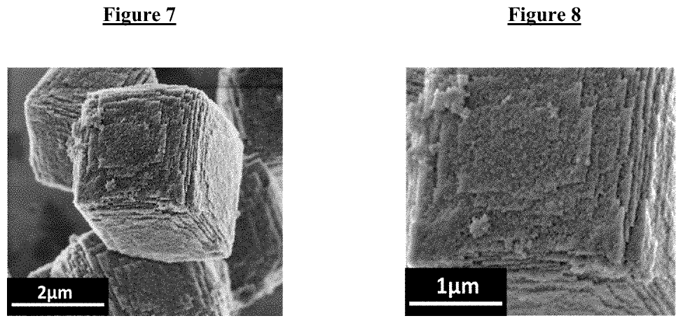

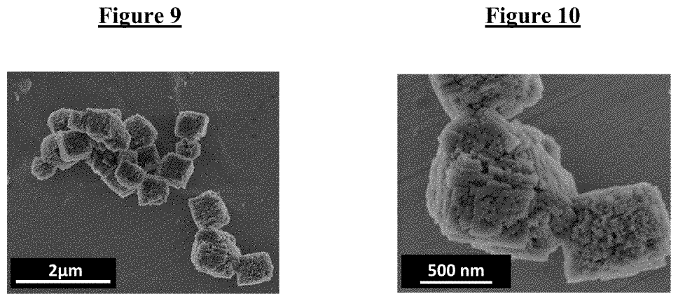

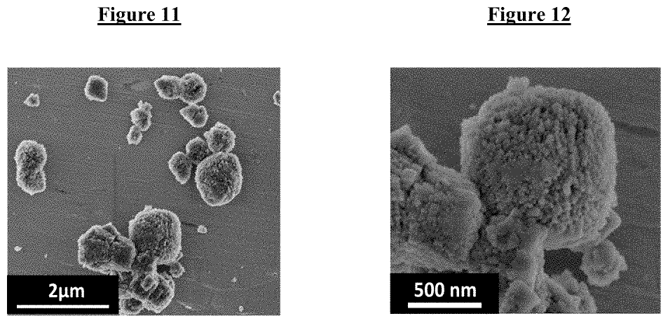

The results are shown in FIGS. 5 to 12, which present the micrographs of the adsorbents synthesized in the presence of the TPOAC surfactant, whose reaction mixture was aged for Oh (without aging the reaction mixture), 48 h, and 96 h. The images show two aspects in relation to the format of the particles from the materials obtained. The first of them refers to the presence of roughness on the surfaces for all adsorbents synthesized with the TPOAC surfactant. The second refers to the diameter of the aged zeolitic particles. The adsorbent obtained without aging the reaction mixture presented an average particle diameter of around 2.3 μm, while the adsorbents obtained after aging the reaction mixture for 48 h and 96 h presented an average particle diameter equal to 632 nm. This was a reduction of approximately 72% in particle size.

From these characterizations, the importance of the addition of an additive to synthesis of the zeolite 4A became evident, with the objective of causing formation of mesoporosity, which is an important factor for diffusing of the reagents to the solid. In addition, aging the reaction mixture also caused a reduction in the size of the zeolite particles, however preserving the mesoporosity created by the TPOAC. These two characteristics in a single material promote better diffusion of the reagents to the adsorbent.

The invention may be used in natural gas drying processes, where the commercial zeolitic adsorbent is used, which does not have mesoporosity or nanometric particle dimensions.

The adsorbent solids obtained with the new method of synthesis developed in this invention have the potential to increase the efficiency of the natural gas drying process, minimizing area, weight, and energy demands.

Drying of the natural gas seeks to eliminate the water present in the vapor phase in the produced gas, which is essential for use of this gas in reinjection in oil reservoirs (to increase the oil recovery factor) or in drainage to land, for use in the country's energy grid, without the risk of formation of hydrates or corrosion.

The natural gas drying step is today a very important step for obtaining gas associated with oil in the production units. Taking the severe restrictions on gas-flaring at the production units into account, the natural gas drying process ultimately allows the production of oil, which is today the most profitable component of oil production.

It should be noted that although the present invention has been described in relation to the attached drawings, it may be modified and adapted by those versed in the matter, depending on the specific situation, but remaining within the inventive scope defined herein.

1-4. (canceled)

5. A method for synthesizing zeolitic solids that comprise mesoporous and controlled-size particles, the method comprising:
preparing solution A by mixing a deionized water, sodium hydroxide, sodium metasilicate, and N,N-dimethyl-N-[3-(trimethoxysilane)-propyl]octadecyl ammonium chloride (TPOAC) and agitating the mixture at 100 rpm to 400 rpm for 15 minutes to 45 minutes or for a sufficient amount of time to dissolve the sodium metasilicate and the TPOAC;
preparing solution B by mixing water, sodium hydroxide, and sodium aluminate and agitating the mixture at 100 rpm to 400 rpm for 15 minutes to 45 minutes or for a sufficient amount of time to dissolve the sodium aluminate;
combining solution A and solution B and agitating the combination mechanically at 400 rpm to 600 rpm for 30 minutes to 190 minutes, until the combination is homogenized, white, and more viscous than solution A and solution B;
dividing the combination into portions, placing the portions in containers, and aging the portions in the containers in one or more thermostatic baths between 25° C. and 35° C. for aging times ranging from 0 to 96 hours;
placing the containers with the aged portions in one or more autoclaves for thermal treatment in an oven, with internal air circulation between 90° C. and 110° C. for 3 hours to 5 hours; and
collecting, cooling, and filtering the thermal treated portions, washing the collected, cooled, and filtered portions with deionized water to a pH of 8.0, and drying the washed collection at 80° C. in an oven.

6. A zeolitic solid as prepared by the method of claim 5, comprising an LTA structure with intercrystalline mesoporosity and a particle size with micrometric or nanometric dimensions.

7. The zeolitic solid of claim 6, wherein the average particle diameter is equal to 632 nm.

8. A method comprising:
using the zeolitic solid as prepared in claim 5 in a natural gas drying process.
